(19) United States
(12) Patent Application Publication
(10) Pub. No.: US 2020/0280780 A1
(43) Pub. Date: Sep. 3, 2020

(54) MICROPHONE MOUNTING SYSTEM FOR DIGITAL DEVICES AND METHOD OF USE

(71) Applicant: Frederick J. Schneider, III, Kansas City, MO (US)

(72) Inventor: Frederick J. Schneider, III, Kansas City, MO (US)

(21) Appl. No.: 16/802,985

(22) Filed: Feb. 27, 2020

Related U.S. Application Data
(60) Provisional application No. 62/812,481, filed on Mar. 1, 2019.

(51) Int. Cl. H04R 1/08; H04B 5/06; H04R 1/04; H04R 3/00

(52) U.S. Cl. CPC H04R 1/083; H04B 5/06; H04R 2420/07; H04R 3/005; H04R 1/04

(57) ABSTRACT

A mounting system which includes a pocket for receiving a digital recorder or a wireless transmitter and a connector for connecting to the body of a microphone device, such as a hand held microphone. The pocket is made of a polyurethane foam and laminated with a four-way stretch nylon fabric which acts to grip the digital recorder or wireless transmitter to prevent it from sliding out of the pocket when handling the microphone. This pocket also covers the logo of the recorder or transmitter and any indicator lights or other indicators on the recorder or transmitter to make the digital recorder or wireless transmitter as visually low profile as possible. The mounting system provides unobstructed access to the microphone's on/off switch and indicator light. The four-way stretch nylon fabric helps retain the digital recorder or wireless transmitter near the top of the microphone.

### CROSS-REFERENCE TO RELATED APPLICATION

This application claims priority in U.S. Provisional Patent Application No. 62/812,481 Filed Mar. 1, 2019, which is incorporated herein by reference.

### BACKGROUND OF THE INVENTION

### 1. Field of the Invention

The present invention relates generally to a mounting system and method for use thereof, and more specifically to a mounting system including a pocket for a digital recorder and for mounting the recorder to a microphone.

### 2. Description of the Related Art

Public speaking events, such as seminars, wedding receptions, talent shows, political debates, and bar mitzvahs, occur every day. These all tend to use an audio enhancement system including a microphone to allow the speaker to be clearly heard by all attendees.

Today, sound amplification at a live event is a given. So much so, that many of these meeting spaces are equipped with a built-in, turn-key audio system. No knowledge of audio equipment or techniques is required to operate these systems. As long as the power button is turned on, and there are fresh batteries in the handheld microphone, the presenter needs only to talk into the microphone, and the audio speakers (often located in the ceiling or walls) faithfully reproduce what is said with enough volume for all to hear. If the venue is not already equipped with such a system, a DJ service is often hired to bring in and setup the necessary audio equipment.

However, many such occasions need to be captured on video as well, for a whole host of reasons. Video production companies are often hired to film, edit and output recordings of these events, for release on Blu-ray disc, or as online content, etc. Getting clean and reliable audio from the event is crucial to producing a good product. And as every video producer knows, “tapping into the soundboard” at one of these live events can be problematic. A myriad of potential problems may be encountered. For instance, if it is a closed turn-key type of system, there may be no jacks available to plug into the equipment. Or, if jacks are available, there may be EQ issues or noise gates applied to the signal that will affect the quality of the recording.

Maybe the microphone that the Best Man speaks into isn't included in the feed. Or there is a slight ringing of feedback, or sibilance throughout. RF interference often appears at the most inopportune time, and the best soundbite of the whole speech can be ruined when that all too familiar “pfffftttt” sound shows up.

What is needed is a discreet way to piggyback a small, professional, and reliable recording device to the microphone that the speaker is using to record high quality, unprocessed audio captured from the same place where the audio is being generated from and picked up by the microphone.

Heretofore there has not been available a system or method for a microphone mounting system for a digital recorder with the advantages and features of the present invention.

### BRIEF SUMMARY OF THE INVENTION

The present invention generally provides a mounting system which includes a pocket for receiving a digital recorder or a wireless transmitter and a connector for connecting to the body of a microphone. The pocket is shaped to fit a typical digital recorder, such as the Sony UX560 digital voice recorder manufactured by the Sony Corporation of Tokyo, Japan, however it could be designed to fit recorders of many sizes and shapes. The pocket is also shaped to fit a wireless transmitter, such as the RODE wireless GO transmitter manufactured by RODE Microphones, LLC of Sydney, Australia.

The pocket provides near-full containment of the digital recorder or wireless transmitter while allowing for unobstructed access to the microphone portion located on the top face of the digital recorder. Both the sleeve and the connector are made of a polyurethane foam, such as a foam known as HyPUR-Cel® manufactured by Rubberlite Inc. of Huntington, W. Va., laminated with a four-way stretch nylon fabric which acts to grip the digital recorder or wireless transmitter to prevent it from sliding out of the pocket when handling the microphone. This pocket also covers the logo of the recorder or transmitter and any indicator lights or other indicators on the recorder or transmitter to make the digital recorder or wireless transmitter as visually low profile as possible.

The flexible laminated foam from which the pocket and the connector are manufactured from allows the device to fit most handheld microphones. The mounting system provides unobstructed access to the microphone's on/off switch and indicator light. The four-way stretch nylon fabric laminating the device ensures that once it is placed in contact with the handle of the microphone it will prevent slippage during use of the microphone and will help retain the digital recorder or wireless transmitter near the top of the microphone.

### BRIEF DESCRIPTION OF THE DRAWINGS

The drawings constitute a part of this specification and include exemplary embodiments of the present invention illustrating various objects and features thereof.

FIG. 1 is a three-dimensional isometric view of a preferred embodiment of the present invention in a typical environment installed on a microphone.

FIG. 2 is a top-down three-dimensional view thereof.

FIG. 3 is a bottom-up three-dimensional view thereof.

FIG. 4 is a rear three-dimensional view thereof.

FIG. 5 is a side elevational view thereof.

FIG. 6 is a partially-exploded three-dimensional isometric view of a preferred embodiment of the present invention.

FIG. 7 is a three-dimensional isometric view thereof shown assembled.

FIG. 8 is a partially exploded three-dimensional view thereof shown in conjunction with a typical environment of a microphone.

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

### II. Preferred Embodiment Microphone Mounting System for Digital Device 2

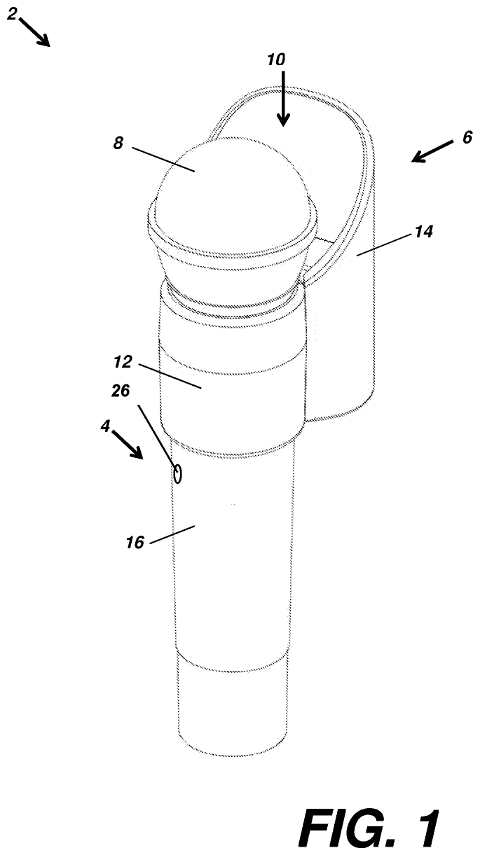

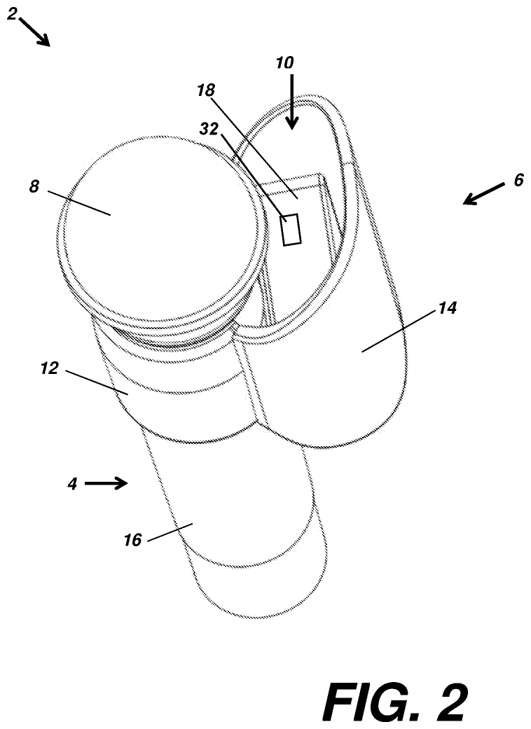

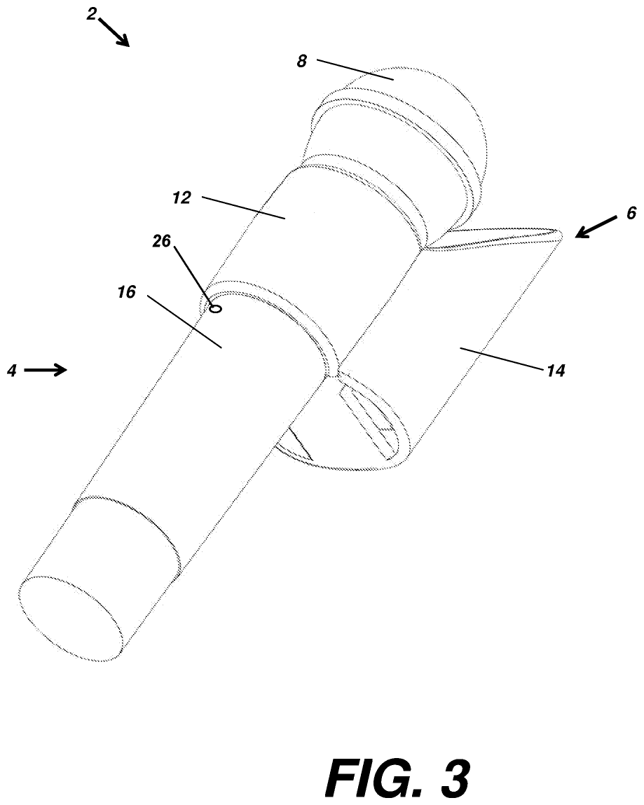

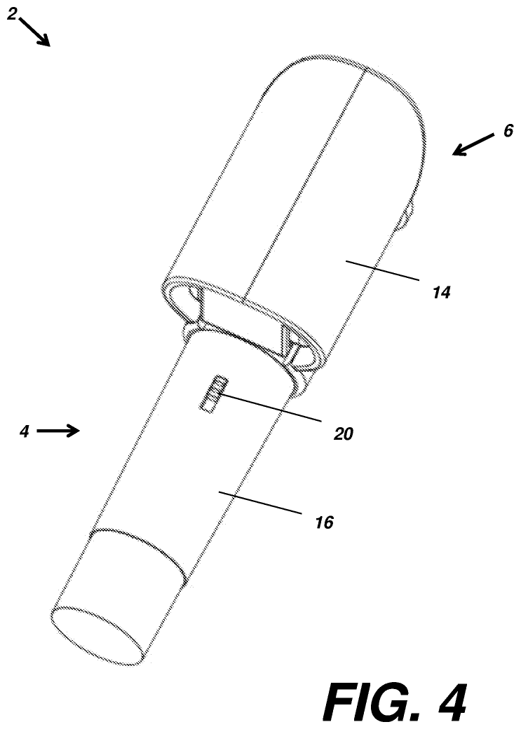

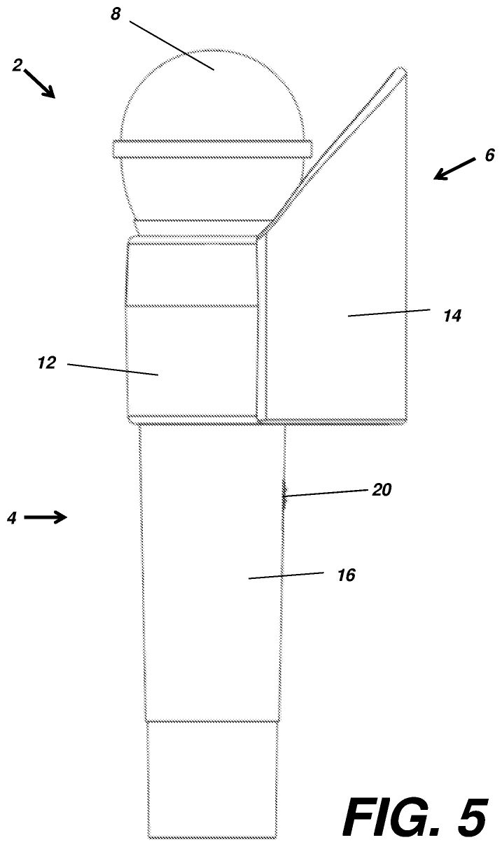

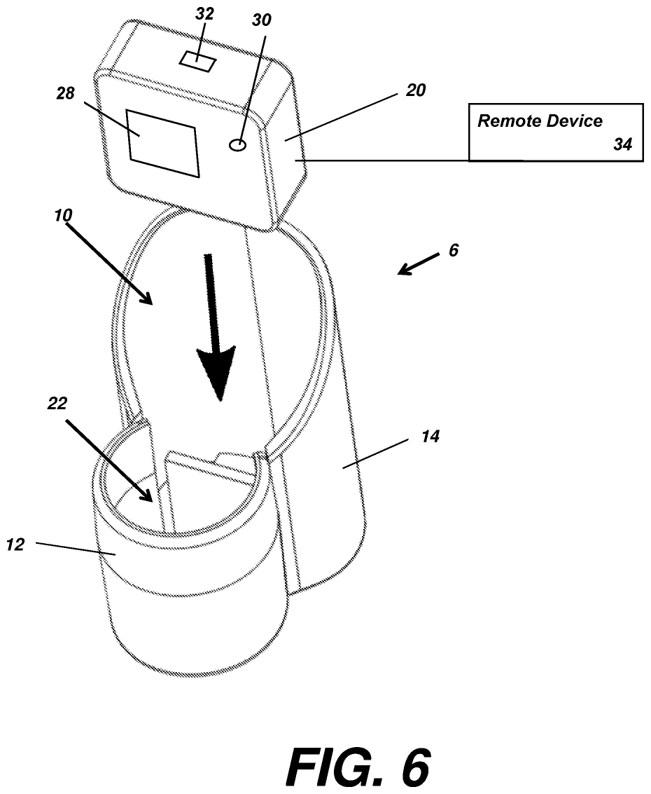

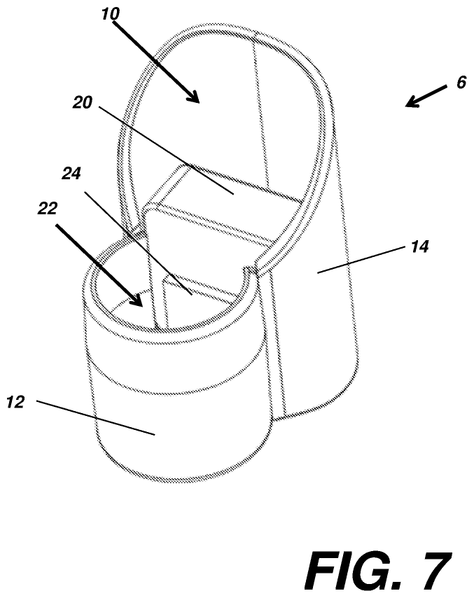

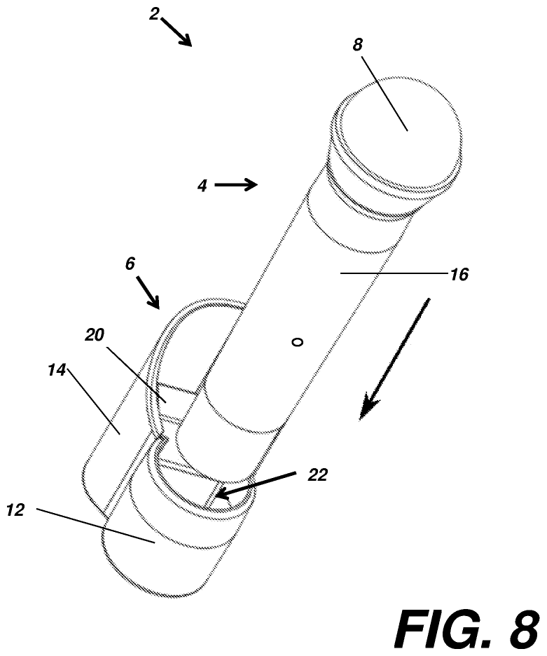

As shown in FIGS. 1-8, the present invention is a mounting system 2 for mounting a digital device 18 to a microphone 4 using a mounting device 6. The mounting device 6 includes a pocket 14 for receiving the digital device 18. The pocket 14 and connector 12, are ideally manufactured from polyurethane foam, such as a foam known as HyPUR-cel® manufactured by Rubberlite Inc. of Huntington, W. Va., laminated with a four-way stretch nylon fabric such that the pocket grips the digital device 18 to prevent the device from slipping out of the pocket 14. The connector 12 is shown as a sleeve in the preferred embodiment, but may be any suitable connector to secure the mounting device 6 to the microphone 4. The pocket 14 ensures that the digital device 18 is in proximity to the head 8 of the microphone 4, which is where sound is directed. In a situation where the digital device 18 is a digital recorder, this provides uninterrupted access to the microphone portion 32 of the recorder via the opening 10 of the pocket 14. This also prevents the device 18 from slipping out of the pocket 14 when the microphone 4 is inverted, and it covers the logo of the device and any indicator lights 30 or displays 28 to make the digital device 18 as visually low profile as possible.

The mounting system includes a connector 12 with an opening 22 for wrapping about the handle 16 of the microphone 4. A wall 24 separates the opening 22 of the connector 12 from the opening 10 of the pocket 14 This connector 12 also allows access to the power switch 20 of the microphone 4, as well as an indicator light 26 showing that the microphone 4 is active (if it exists), while securing the digital device 18 in place. If the digital device 18 is a digital recorder, this ensures that the microphone of the digital recorder is in proximity with the head 8 of the microphone 4. This ensures that whatever is said into the microphone itself will be picked up by the digital recorder microphone 32 as well. If the digital device 20 is a digital transmitter, this ensures that the transmitter has good clearance to transmit audio data to a remote receiver device 34, which in turn can be connected to a recording or amplifying device, such as a DSLR camera or an audio soundboard. The present invention ensures clear audio transfer to the remote receiver device 34 by ensuring that the microphone 32 of the digital device 18 is in proximity to the head 8 of the microphone 4.

The connector 12 leaves enough room on the handle 16 of the microphone 4 for the microphone to be mounted within a standard microphone stand. This would allow the mounting system 2 to be used during political speeches, during orchestra performances, or any other situation where a microphone stand is used.

It is to be understood that while certain embodiments and/or aspects of the invention have been shown and described, the invention is not limited thereto and encompasses various other embodiments and aspects.

Having thus described the invention, what is claimed as new and desired to be secured by Letters Patent is:

1. A mounting device comprising:
a connector and a pocket;
said pocket configured to receive a digital device;
said connector configured to be placed about a handle of a microphone device comprising a first microphone;
said digital device comprising a second microphone;
wherein said digital device is situated by said connector such that said second microphone is in proximity to said first microphone; and
said pocket configured to secure said digital device within an opening of said pocket.

2. The mounting device of claim 1, further comprising:
said connector and said pocket being constructed from a polyurethane foam; and
said connector and said pocket being further constructed from a four-way stretchable fabric affixed to an exterior of said polyurethane foam.

3. The mounting device of claim 2, wherein said four-way stretchable fabric is configured to grip against said digital device, thereby preventing slippage.

4. The mounting device of claim 2, wherein said four-way stretchable fabric is configured to grip against said handle of said microphone, thereby preventing slippage.

5. The mounting device of claim 1, wherein said digital device comprises a wireless transmitter having a transmitter microphone.

6. The mounting device of claim 5, further comprising:
a remote wireless receiver; and
said remote wireless receiver wirelessly connected to said wireless transmitter such that audio captured by said transmitter microphone is wirelessly transferred to said remote wireless receiver.

7. The mounting device of claim 1, wherein said digital device comprises a digital audio recorder.

8. A mounting system for mounting a digital device to a hand held microphone having a handle, the system comprising:
a digital device mount comprising a connector and a pocket;
said pocket configured to receive a digital device;
said connector configured to be placed about the handle of the hand held microphone, said hand held microphone comprising a first microphone;
said digital device comprising a second microphone;
wherein said digital device is situated by said connector such that said second microphone is in proximity to said first microphone;
said pocket configured to secure said digital device within an opening of said pocket;
said connector and said pocket being constructed from a polyurethane foam; and
said connector and said pocket being further constructed from a four-way stretchable fabric affixed to an exterior of said polyurethane foam.

9. The mounting device of claim 8, wherein said four-way stretchable fabric is configured to grip against said digital device, thereby preventing slippage.

10. The mounting device of claim 8, wherein said four-way stretchable fabric is configured to grip against said handle of said microphone, thereby preventing slippage.

11. The mounting device of claim 8, wherein said digital device comprises a wireless transmitter having a transmitter microphone.

12. The mounting device of claim 11, further comprising:
a remote wireless receiver; and
said remote wireless receiver wirelessly connected to said wireless transmitter such that audio captured by said transmitter microphone is wirelessly transferred to said remote wireless receiver.

13. The mounting device of claim 8, wherein said digital device comprises a digital audio recorder.

14. A method of mounting a digital device to a microphone enclosure, the method comprising the steps:
connecting a digital device mount to a handle of the microphone enclosure by wrapping a connector of said digital device mount about said handle, said microphone enclosure comprising a first microphone;
placing a digital device within a pocket of said digital device mount, said digital device comprising a second microphone;
positioning said digital device such that said second microphone is in proximity to said first microphone; and
securing said digital device within said pocket.

15. The method of claim 14, further comprising the steps:
said digital device mount pocket and connector being constructed from a polyurethane foam;
said connector and said pocket being further constructed from a four-way stretchable fabric affixed to an exterior of said polyurethane foam;
preventing said connector from slipping against said handle of said microphone enclosure via said four-way stretchable fabric; and
securing said digital device within said pocket via said four-way stretchable fabric.

16. The method of claim 14, further comprising the steps:
said digital device comprising a digital transmitter;
wirelessly communicating audio received by said second microphone from said digital transmitter to a remote receiver; and
receiving said audio received by said second microphone with said remote receiver.

17. The method of claim 14, further comprising the steps:
said digital device comprising an indicator light; and
blocking said indicator light with said pocket.

18. The method of claim 14, further comprising the steps:
said digital device comprising a display; and
blocking said display with said pocket.
